(19) United States
(12) Patent Application Publication
(10) Pub. No.: US 2026/0100086 A1
(43) Pub. Date: Apr. 9, 2026

(54) GAMING MACHINE WITH MOUNTING ASSEMBLY FOR SUPPORTING ELECTRONIC DISPLAY SCREENS

(71) Applicant: Incredible Technologies, Inc., Vernon Hills, IL (US)

(72) Inventors: Omar Torres, Barrington, IL (US); Lawrence J. Hodgson, Las Vegas, NV (US); Steve Jaskowiak, Sleepy Hollow, IL (US); Guillermo Ramirez Carmona, Chicago, IL (US)

(21) Appl. No.: 18/906,022

(22) Filed: Oct. 3, 2024

(51) Int. Cl. G07F 17/32

(52) U.S. Cl. CPC G07F 17/3211; G07F 17/3216

(57) ABSTRACT

A gaming machine comprising a cabinet and a mounting assembly having a slide mechanism. The mounting assembly comprises first and second segments. A display screen is securable to the mounting assembly. The slide mechanism is provided between the first and second segments and comprises a first profile and a second profile. The first profile is secured along one of an interior or exterior surface of side support members of the first segment. The second profile is secured along an interior or an exterior surface of side support members of the second segment. The second profile is slidingly engaged with the first profile. The second segment is configured for telescoping linear travel relative the first segment between a first position nested within the first segment and a second position extending below the first segment. The telescoping linear travel is provided by the second profile sliding along the first profile.

### FIELD

Embodiments presented herein relate generally to gaming machines, and more particularly to gaming machines having an assembly for mounting and supporting electronic display screens.

### BACKGROUND

Gaming machines having electronic display screens are generally well known in the art. Frequently such machines utilize one or more display screens to visually present elements of electronic games, such as for example arrays for a primary or base game, elements associated with bonus games, progressive games or jackpots and/or graphical user interfaces for receipt of touch input to control the games played thereon or to enable the selection of wagers or other inputs associated with the game. In some instances, electronic display screens can be incorporated into a housing or cabinet of gaming machines, whereas in other cases the screens can be affixed or secured to the exterior of the gaming machine cabinet.

In recent years, some gaming machine manufacturers have started developing electronic gaming machines having taller configurations where flat or curved display screens are oriented in a stacked orientation comprising a first primary electronic display screen and an upper electronic display screen located above the primary display. Such gaming machine configurations have been found to be appealing to both gaming operators and patrons on account of providing an expanded visual presentation and experience, including the ability to see such gaming machines from across the floor of a casino above lower profile gaming machines.

Although advancements in electronic display technology over the years have resulted in display screens having a thinner and more lightweight design, display screens used with electronic gaming machines can still be difficult to install, service and replace. This is especially the case for those gaming machines referenced previously that have a stacked display configuration with an upper display screen. In many instances, the mounting locations for an upper display screen of such gaming machines can be elevated between six and ten feet above the floor. At such heights, the lifting, assembly and/or installation of such top display screens can require multiple service technicians on ladders or lifts to hold the display until it is secured in place. Servicing an elevated upper display screen can also be problematic and in many instances and can require multiple technicians to mechanically detach the display screen and manually lower it to an elevation where it can be readily accessed. Such operations can be time consuming and labor intensive and can also result in damage to the display device from mishandling, or even injury to a service technician from falling from a ladder or mechanical lift.

Gaming machine display screens that are not used in an elevated position can also be problematic to install and service in that the mounting points can be difficult to engage thus requiring assistance to hold the display device in place until it is able to be secured. Such assistance may require a second service technician or other mechanical device which can increase installation time. Known mounting arrangements and assemblies can also conceal or obstruct electronic connection points which can make it difficult to service or replace the display screen or the wiring or cables connecting the display screen to the game computer within the cabinet of the machine.

Although efforts have been made to provide assemblies for mounting a display screen to a gaming machine cabinet, conventional systems can involve complex linkage assemblies or mechanical assist devices that include motors, gas springs, dampers, torsion bars, winches or pulleys. Unfortunately, complex linkage assemblies can be comprised of numerous links and/or joints that can be susceptible to wear or breakage. Mechanical assist devices can also be susceptible to frequent wear and costly to implement and repair/replace.

In view of the foregoing, there is a need in the art for improved mechanical mounting assemblies for supporting electronic display devices of gaming machines and a gaming machine cabinet incorporating such mounting assemblies. There is further a need for such mounting assemblies to have the capability to extend into a position where a display screen can be installed by a single service technician and readily serviced without the need for assistance with supporting or holding the display screen or incurring frustration from the need to access obstructed connection points. There is further a need that such assemblies be easy to use and not be readily susceptible to wear or breakage.

### BRIEF DESCRIPTION OF THE DRAWINGS

FIG. 1 is a schematic perspective view of a gaming machine according to embodiments disclosed herein.

FIG. 2 is a schematic elevation view of the gaming machine of FIG. 1.

FIGS. 3A through 3D are a sequence of schematic elevation views of a gaming machine illustrating movement of an upper display device in accordance with embodiments disclosed herein.

FIG. 4 is a schematic perspective view of an assembly for supporting a display device in accordance with embodiments disclosed herein.

FIG. 5 is a schematic perspective view of the assembly of FIG. 4 in a lowered/extended position in accordance with embodiments disclosed herein.

FIG. 6A through 6D are a sequence of schematic partial section elevation views of a gaming machine illustrating an assembly for supporting a display device in accordance with embodiments disclosed herein.

FIG. 7 is a schematic perspective view of an assembly for supporting a display device in accordance with embodiments disclosed herein.

FIG. 8 is a schematic perspective view of the assembly of FIG. 7 in an extended position in accordance with embodiments disclosed herein.

### DETAILED DESCRIPTION

While elements disclosed herein are susceptible of embodiment in many different forms, there are shown in the drawings, and will be described herein in specific detail, representative embodiments thereof with the understanding that the present disclosure is to be considered as an exemplification of the principles of the invention and is not intended to limit the invention to the specific embodiments illustrated.

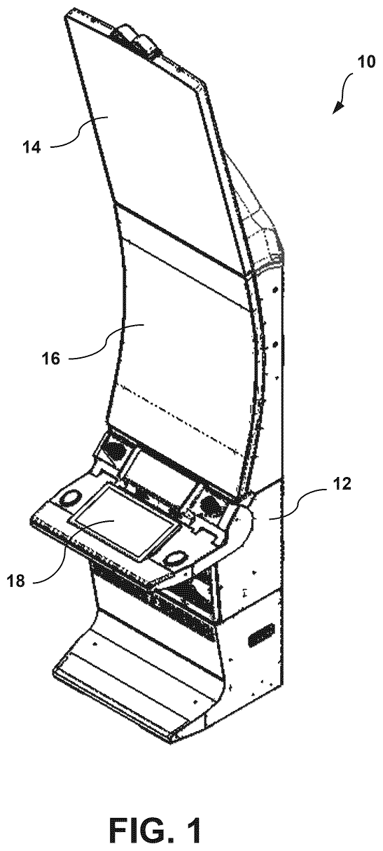

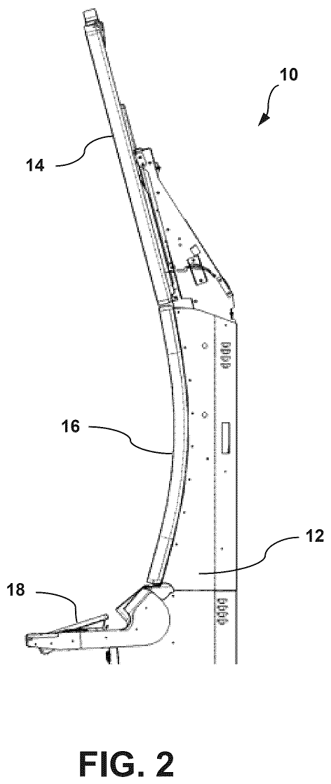

With reference now to the figures, FIGS. 1 and 2 illustrate a gaming machine 10 shown in a condition for intended use in accordance with representative embodiments disclosed herein. As shown schematically in FIGS. 1 and 2, gaming machine 10 can have a cabinet or housing 12 and one or more electronic display devices 14, 16, 18. Electronic display devices can include a display screen in the nature of a liquid crystal display (LCD), light emitting diode (LED) or organic light emitting diode (OLED) display, cathode-ray tube (CRT), plasma display or any other display technology without limitation. Electronic display devices, 14, 16, 18 can include an upper display screen 14, a lower display screen 16 and a control deck display screen 18.

As best shown in FIG. 2, upper display screen 14 can be a flat panel display and lower display screen 16 can be a curved panel display located below upper display screen 14. Without limitation however, a curved panel display can be utilized for the upper display screen 14 and a flat panel display can be utilized for the lower display screen 16 without departing from the scope of invention. According to exemplary embodiments, upper and lower display screens 14, 16 can have a substantially identical width with upper display screen 14 being directly above lower display screen 16 as shown in FIGS. 1 and 2, or upper and lower display screens 14, 16 can have alternate dimensions, shapes or proportions or be oriented in an offset configuration relative one another as preferred. Moreover, although embodiments illustrated in the figures show both upper and lower displays oriented in a vertically oriented “portrait-style” orientation, either or both displays can be oriented in a horizontal “landscape-style” orientation or other configuration as preferred.

As shown in FIGS. 1 and 2, cabinet 10 can have a lower base portion, upper portions above the base portion and a control deck extending forward from the front of cabinet 10. Upper and lower display screens 14, 16 can be secured to cabinet 12 along a front side of gaming machine 10 with the upper portions of cabinet 12 located behind the upper and lower display screens 14, 16. The lower base portion of cabinet 12 can house a game computer or processing unit and circuitry for gaming machine 10 and upper portions of cabinet can enclose and conceal cables and wiring electrically connecting the display machines to the game computer or processing unit.

According to exemplary embodiments, control deck display screen 18 can be secured along the top surface of the control deck adjacent buttons, indicator lights, audio speakers, and card or credit input devices. Control deck display screen 18 (and at least a portion of lower display screen 16) can be configured to have touch-screen capability for receipt of player input, such as a touch sensor assembly or interface comprising a substantially transparent touch panel, a touch panel controller and associated software for controlling and interpreting touch data.

According to embodiments presented herein, lower display 16 can be configured and used as a main or primary display for games played on gaming machine 10 and can visually display graphics, information and other elements associated with play of a base game or bonus games, whereas upper display 14 can be configured and used as an auxiliary display for such games and can visually display graphics, information and other elements that supplement or enhance the visual presentation of the game such as dynamic graphics moving from the main display, quantitative information regarding game outcomes and jackpots and other bonus game elements. Thus, upper and lower display screens 14, 16 can be configured for extended presentation whereby graphics can extend across or move between displays. Upper and lower display screens 14, 16 can also be configured to display content independent from one another (in a non-extended format) or transition between extended and non-extended presentations. Notwithstanding the foregoing, persons of ordinary skill in the art will recognize and appreciate that the configuration and use of upper and lower display screens 14, 16 in connection with a game played on machine 10 is not limited to any particular format or presentation and that such displays can be utilized to provide visual content in any number of configurations without limitation, and without departing from the scope of embodiments disclosed herein. More particularly, embodiments presented herein can utilize upper display screen 14 as the primary display and lower display screen 16 as an axillary display for a game played thereon (or any portion of such game).

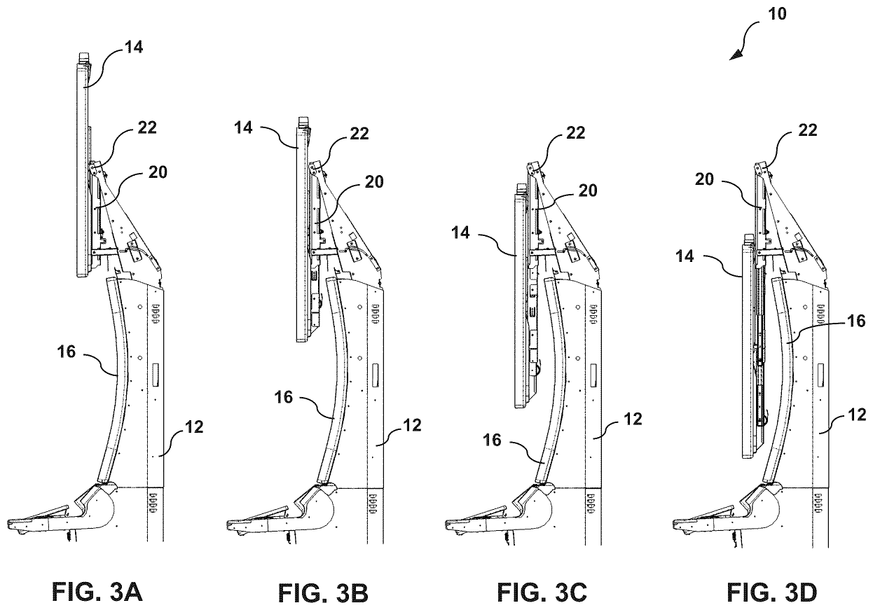

As shown schematically in FIGS. 3A through 3D, embodiments presented herein comprise a mounting assembly 20 that can provide for raising and lowering upper display screen 14 to facilitate easier and more efficient installation and service of the upper display screen. More particularly, from the position of intended use shown in FIGS. 1 and 2, upper display screen 14 can be disengaged from the front side of the upper portion of cabinet 12 as shown in FIG. 3A such that the bottom portion of upper display screen 14 can swing or rotate forward and away from cabinet 12. Such rotation can be provided by a hinged connection 22 between the upper portion of cabinet 10 and the upper portion of the mounting assembly for upper display 14.

According to exemplary embodiments, the forward rotation of the bottom portion of upper display screen 14 can move the display screen into a substantially vertical or upright orientation. Such vertical orientation can be facilitated by the shape of the upper portion of cabinet 12 and the attachment position between the cabinet and upper display screen 14. More particularly, the upper portion of cabinet 12 can slope forward such that when upper display is secured to the cabinet in a condition for use it can be pitched with a top end of display 14 projecting forward and the bottom end set back therefrom. The upper portion of cabinet 12 can have a latching mechanism securing upper display screen 14 to the upper portion of cabinet 12 for use. Upon the release of latching mechanisms, the bottom end of upper display screen can rotate down and forward under the influence of gravity enabling the upper display screen to move into a vertical orientation.

According to embodiments shown schematically in FIGS. 3A through 3D, the arrangement of the upper display screen 14 in a substantially vertical orientation can cooperatively enable vertical movement of the upper display screen between a raised position as shown in FIG. 3A and a lowered position as shown in FIG. 3D. In traveling between the raised and lowered position, upper display 14 can pass in front of lower display screen 16 where the back of the upper display screen 14 is spaced-apart from the front of lower display screen 16. The space between the back of the upper display screen 14 and the front of the lower display screen 16 can provide access to the rear of the upper display screen to enable a service technician to view and access ports located on the back of the display and connectors plugged therein for maintenance and/or service work. The lowered position can also better enable a technician to install or replace upper display 14 since it is closer to the ground and does not require the technician to work from an elevated position or attempt to manually lower the upper display from a ladder or lift. Such benefits can enable service work to be conducted faster and more economically and efficiently.

The path of vertical travel of the upper display screen 14 shown in FIGS. 3A through 3D and the corresponding space between the rear side of upper display 14 and the front of lower display 16 can be attributable in-part to design of the upper portions of cabinet 12 and the location of the hinged connection 22 between the mounting assembly 20 and cabinet 12. More particularly, as shown in FIGS. 3A through 3D, the upper portion of cabinet 10 can be pitched forward as it extends upward from the cabinet portion behind the lower display screen 16. Such configuration enables the hinged connection 22 between the mounting assembly 20 and cabinet 12 to be located in front of the lower display screen such that the upper display screen 14 (and mounting assembly) have sufficient clearance from the lower display screen 16 when traveling to/from the lowered position.

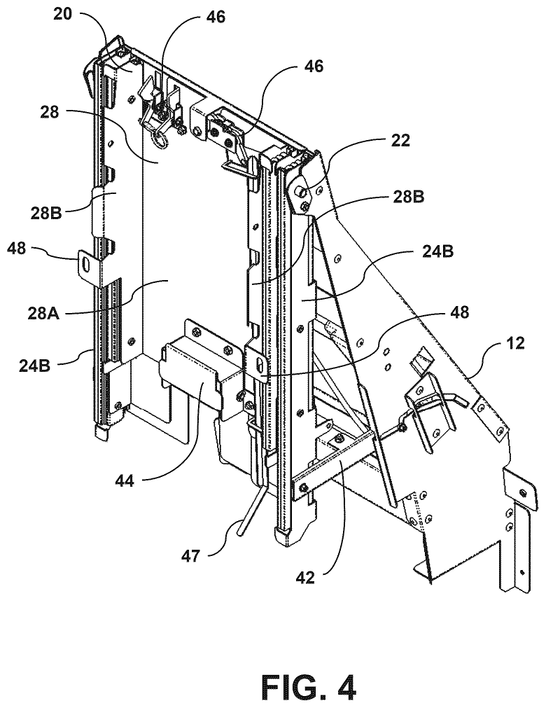

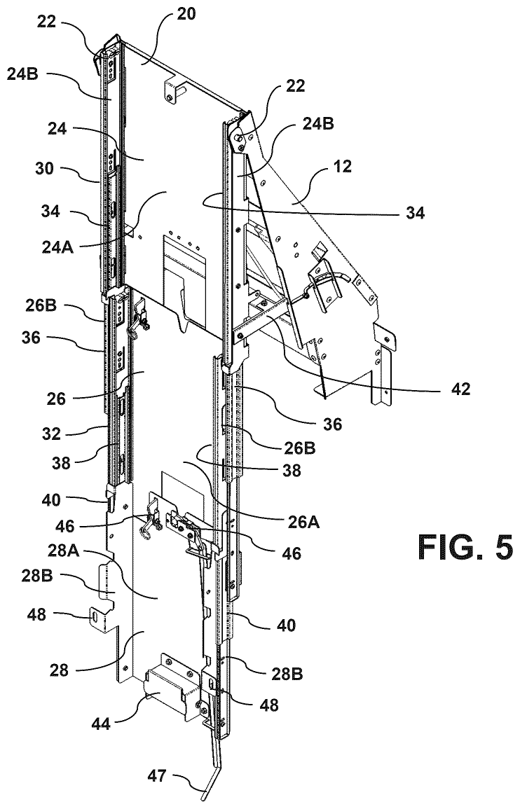

FIGS. 4 and 5 illustrate the mounting assembly 20 for the upper display screen 14 in accordance with embodiments presented herein (shown without the display screen for clarity). More particularly, FIG. 4 illustrates mounting assembly 20 in a raised position where display screen 14 would be in a vertical orientation consistent with FIG. 3A. As described previously, this position can be achieved by the bottom portion of the display being rotated forward from its position of intended use against the upper portion of cabinet 12. FIG. 5 illustrates mounting assembly 20 in a fully extended position consistent with FIG. 3D where upper display screen 14 would be fully lowered in front of the lower display screen.

As best shown in FIG. 5, mounting assembly 20 can have a plurality of segments 24, 26, 28 that can comprise a rear support member 24A, 26A, 28A such as a rigid back panel and spaced-apart side support members 24B, 26B, 28B extending along opposing sides of segments 24, 26, 28 and along the sides of the rear support member. Although FIGS. 4 and 5 illustrate rear support members 24A, 26A, 28A as being a panel extending along the vertical length of segments 24, 26, 28 it will be understood that such members can have alternate configurations including, without limitation, a plurality of cross supports with spaces therebetween (with together with the side supports can have a configuration similar to a ladder) or cross supports adjacent the top and bottom ends of the segments with a central opening (with together with the side supports can have a configuration similar to a picture frame).

As shown schematically in FIG. 5, segments 24, 26, 28 of mounting assembly 20 can each have a first top end and an opposing second bottom end. According to exemplary embodiments best shown in FIG. 5, the top end of segment 24 can be hingedly secured to cabinet 12 by way of fasteners coupling the cabinet to the opposing side support members 24B at a location adjacent the top end of segment 24. Such hinged connection 22 can enable the mounting assembly to rotate between at least a forward service position where mounting assembly 20 is substantially vertically oriented as shown in FIGS. 4 and 5 and a use position where the bottom of mounting assembly 20 is rotated back towards the upper portion of cabinet 12 (consistent with the position of intended use as shown in FIGS. 1 and 2). Upon be rotated into the use position, at least a portion of mounting assembly 20 can be rotated to nest within cabinet 12 such that the sides of cabinet enclose the side support members 24B, 26B, 28B.

Mounting assembly 20 can further comprise a kick stand 42 that can detachably couple a lower portion of segment 24 to cabinet 12. According to embodiments presented herein, kick stand 42 can have an elongated configuration having opposing proximal and distal ends. The proximal end can be hingedly secured to a location along the inside of cabinet 12 in a manner that enables the kick stand to rotate about the proximal end. Upon the mounting assembly 22 being released from its use position, kick stand 42 can be rotated to enable the opposing distal end to latch to a corresponding mounting point on the mounting assembly including along the side support member 24B. Kick stand 42 can hold the mounting assembly 20 in a vertical orientation and prevent it from rotating back toward the cabinet. Such utilization can better enable a technician to work on a display screen secured to the mounting assembly 20 without the lower end moving/rotating.

According to embodiments shown in FIGS. 4 and 5, the opposing side support members 28B of segment 28 can comprise brackets or flanges 48 for mounting the upper display (not shown) to mounting assembly 22. More particularly, a mounting bracket can be utilized and secured to the rear portion of the upper display screen and the mounting bracket can be secured to the brackets or flanges 48 by way of mechanical fasteners.

As best shown in FIG. 5, mounting assembly 20 can include a plurality of slide mechanisms 30, 32 to enable linear movement of segments 26 and 28 in a vertical direction. As shown schematically in FIG. 5, each slide mechanism 30, 32 can comprise first and second profiles that slidingly engage each other in a telescoping manner. It will be appreciated that the general construction and operation of slide mechanisms 30, 32 can correspond to drawer slides that are conventionally used in connection with cabinet or furniture drawers, certain general properties of which are disclosed in U.S. Pat. Nos. 4,119,377, 5,316,389 and 5,577,821 which are hereby incorporated by reference.

According to embodiments presented herein, a first slide mechanism 30 can be utilized between first and second segments 24, 26 of mounting assembly 20. As shown in FIG. 5, first slide mechanism 30 can include a pair of first profiles 34 secured to inside surfaces of the opposing side support members 24B of first segment 24 which can extend vertically upward from or around the bottom edge of segment 24 along at least a portion of the inside edge of the side support members 24. First slide mechanism 30 can further include a pair of second profiles 36 comprising outside surfaces of the opposing side support members 26B of second segment 26 which can extend vertically downward from or around the upper edge of segment 26 along at least a portion of the outside edge of the opposing side support members 26B.

In operation, the first and second profiles 34, 36 of the first slide mechanism 30 can slidingly engage each other in a telescoping manner such that one of the profiles comprises an outer rail having an interior track or channel defined by opposing raised edges and the other of the profiles comprises an inner rail that is configured for fitting within the interior track or channel of the outer rail.

The second slide mechanism 32 can be utilized between second and third segments 26, 28 of mounting assembly 20. As shown in FIG. 5, second slide mechanism 32 can include a pair of first profiles 38 secured to inside surfaces of the opposing side support members 26B of second segment 26 which can extend vertically upward from or around the bottom edge of segment 26 along at least a portion of the inside edge of the side support members 26. Second slide mechanism 32 can further include a pair of second profiles 40 along the outside surfaces of the opposing side support members 28B of third segment 28 which can extend vertically downward from or around the upper edge of segment 28 along at least a portion of the outside edge of the opposing side support members 28B.

In operation, the first and second profiles 38, 40 of the second slide mechanism 32 can slidingly engage each other in a telescoping manner such that one of the profiles comprises an outer rail having an interior track or channel defined by opposing raised edges and the other of the profiles comprises an inner rail that is configured for fitting within the interior track or channel of the outer rail.

As is generally known with conventional drawer slide mechanism, the mated pairs of first and second profiles of slide mechanisms 30, 32 can coupled or operatively engaged by ball bearings or rollers that can roll as the inner rails slide along the respective channels of the outer rail to facilitate smooth linear sliding movement of the profiles relative one another. Side mechanisms 30, 32 utilized according to embodiments presented herein can further include an intermediate profile that slides relative the first and second profiles.

According to embodiments shown in FIGS. 4 and 5, slide mechanisms 30, 32 can enable segments 26, 28 of mounting assembly 20 to travel in a linear vertical direction between a raised position (as shown in FIG. 4) and a lowered position (as shown in FIG. 5). In the raised position, the segments 24, 26, 28 can nest within one another such that segment 28 is nested within segment 26 and segment 26 is nested within segment 24. Mounting assembly 20 can be lowered from the raised position by pulling segment 28 (or a display screen secured thereto) in a downward direction. Upon segment 28 or display being pulled down, profiles 38, 40 of slide mechanism 32 can move relative one another to cause segment 28 to slide downward relative segment 26 moving segment 28 out of its nested position. The exertion of continued downward pulling of segment 28 or a corresponding display secured thereto can cause profiles 34, 36 of first slide mechanism 30 to move relative one another to cause segment 26 to slide downward relative segment 24 moving segment 26 out of the nested position inside segment 24.

Mounting assembly 20 can be raised from the lowered position to the upper position by pushing lower segment (or a corresponding display screen secured thereto) in an upward direction. According to exemplary embodiments, mounting assembly 20 can comprise a biasing member such as a spring that can facilitate upward travel of segments 26, 28 without undue exertion and cooperatively prevent the mounting assembly 20 and display screen from freely or rapidly descending from the raised position by the force of gravity from the weight of the assembly and display screen. More particularly, upon being in the raised position, the spring or biasing member can be in a natural coiled and compressed state. Upon the mounting assembly 20 or display being pulled downward, the spring can expand and at least partially uncoil providing a spring force which can at least in part resist or counterbalance downward force being exerted on the mounting assembly and display screen. Upon the mounting assembly 20 or display screen being pushed upward, the spring can be influenced to return to its natural coiled state and generate an upward pulling force to assist with raising the mounting assembly 20 back to the raised position. According to exemplary embodiments shown in FIGS. 4 and 5, segment 28 of mounting assembly 20 can comprise a housing 44 enclosing the spring.

Mounting assembly 20 can further comprise latches 46 to hold the assembly and mounted display screen in the raised position. As shown in FIGS. 4 and 5, latches 46 can be located proximate the top of mounting assembly 20 along segment 24. Upon the display and mounting assembly being moved into the raised position, latches 46 can frictionally engage locations along segment 28 such as the opposing side support members 28B. According to exemplary embodiments, actuating release lever 47 can cause latches 46 to release from segment 28 to permit segments 26 and 28 to extend downward.

From the foregoing, persons of ordinary skill in the art will appreciate that the mounting assembly 20 presented herein can provide an improved configuration for mounting and moving a display screen between a raised position for use as an upper display screen of a gaming machine and a lowered position where it can be readily accessed for installation, service or replacement. It will be further understood and appreciated that such mounting assembly can enable an upper display screen to be installed, serviced or replaced by a single service technician and without the need for ladders or mechanical lifts. Such benefits can decrease the time and expense of service work so that the gaming machine can be configured for or returned to operation more rapidly. It will be further understood that such benefits can increase opportunities for play the gaming machine which can be desirable to both players and gaming operators.

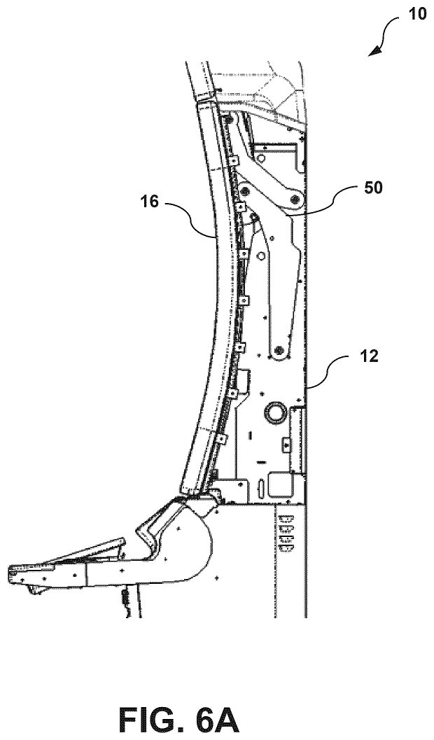

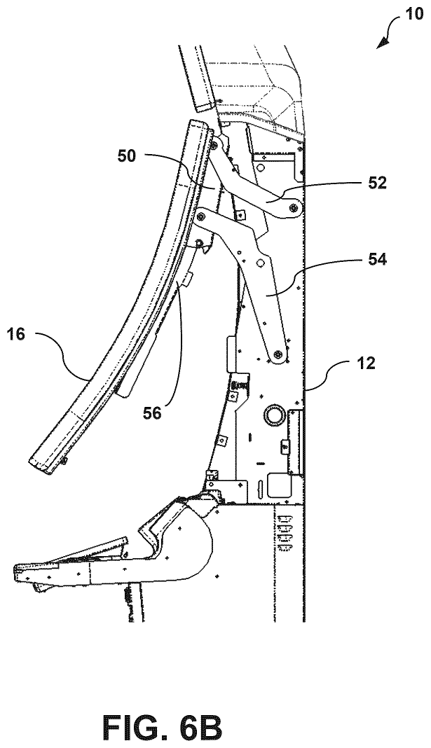

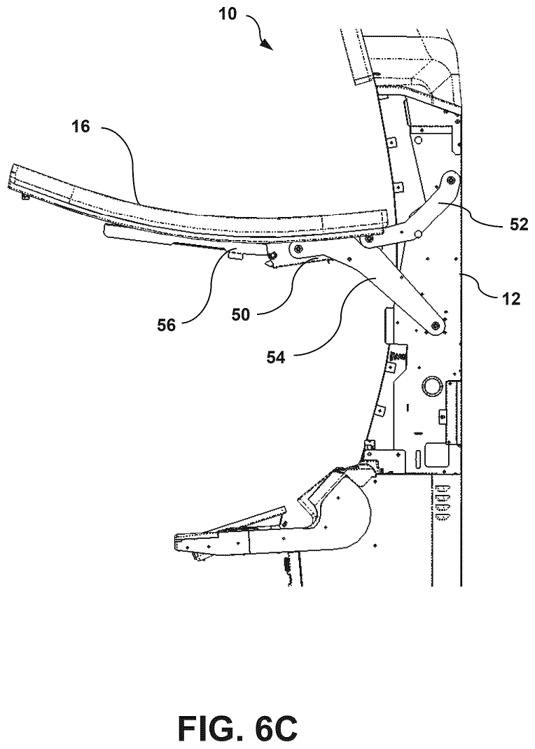

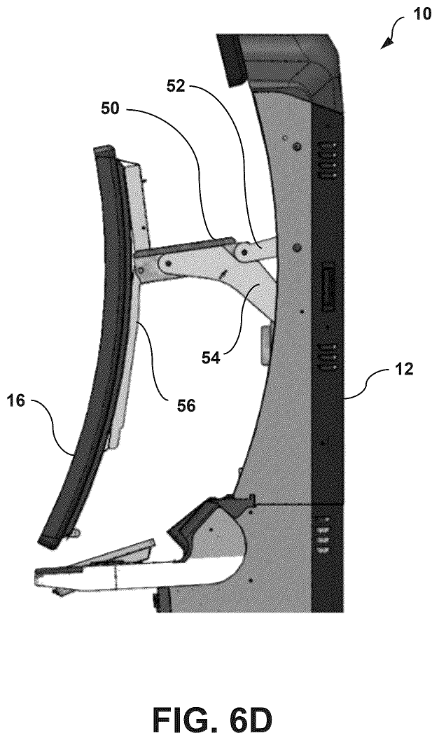

FIGS. 6A through 6D illustrate side elevation views of a portion of gaming machine 10 according to embodiments presented herein, including display screen 16 and a portion of cabinet 12 adjacent the display screen. For ease of understanding, the near side panel of cabinet 10 has been omitted from FIGS. 6A through 6D. As shown schematically in FIGS. 6A through 6D, gaming machine 10 can comprise mounting assembly 50 for moving display screen 16 from a position of intended use along the front of cabinet 12 to an extended position for improved access to facilitate installation and service of the display. More particularly, FIG. 6A shows display screen 16 secured to the front portion of cabinet 12 in a position for intended use to display of a game played on machine 10. In such configuration, mounting assembly 50 supporting display screen 16 can be secured to cabinet 12 in a raised/folded position via one or more latch mechanisms. Upon releasing the one or more latch mechanisms, mounting assembly 50 can disengage from the raised/folded position and cause display screen 16 to move outward in front of cabinet 12 as shown in FIG. 6B.

As shown schematically in FIG. 6B and described more fully below, the movement of display screen 16 outward from cabinet 12 can be provided by sets of rigid arm members 52, 54 of mounting assembly 50 which can rotate downward causing the mounting assembly to descend from the raised/folded position show in FIG. 6A towards an extended position as shown in FIGS. 6C and 6D. Such movement can be aided by the weight of the display screen 16 that can pull arm members 52, 54 downward under the force of gravity toward a fully extended position. From the embodiments shown in FIGS. 6C and 6D, persons of ordinary skill in the art will appreciate that the movement of display screen 16 downward and away from cabinet can expose the rear side of display screen 16 including the A/V ports and power receptacles to better facilitate service of the display and for ease of installing the display to mounting assembly 50.

According to exemplary embodiments, display screen 16 can be rotationally secured to mounting bracket 50. More particularly, the rear surface of display screen 16 can be equipped with a mounting frame 56 that can be detachably secured to mounting assembly by way of a rotational connection. Such rotational connection along mounting frame 56 can be located between the top and bottom of display screen 16 such that a portion of display screen 16 is on either side of the point of rotation. Thus, upon extending away from cabinet 12, display screen 16 can be reoriented from a generally reclined position with the display surface facing upward as shown in FIG. 6C into a substantially upright position as shown in FIG. 6D with the display surface facing outward. Rotation of display screen 16 into the upright position of FIG. 6D can best be accomplished by manually pressing down upon the front display surface side at a bottom portion of display screen 16 to cause the bottom of display screen 16 to rotate downward or by manually pulling upward upon the rear side of a top portion of the display screen 16. According to preferred embodiments, the upright orientation of display screen 16 as shown in FIG. 6D is preferably intended for installation of the display screen 16 and mounting frame 56 to mounting assembly 50, and the reclined orientation of display screen 16 as shown in FIG. 6C is preferably intended for service of the display screen by providing access to the downward-facing rear portion thereof such that it is more accessible to a technician standing in front of the machine.

According to embodiments presented herein, upon being moved into an extended position as shown in FIGS. 6C and 6D, mounting assembly 50 can be returned to the raised/folded position of FIG. 6A. Where display screen 16 is in a upright orientation as shown in FIG. 6D, the return to the raised/folded position can be most easily accomplished by rotating display screen to a reclined position as shown in FIG. 6C. Such rotation can best be accomplished by manually pulling the rear side of a bottom portion of display screen 16 upward or manually pushing the front display surface side of a top portion of the display screen downward. Upon being moved into the reclined orientation (or in concert with such rotation), display screen 16 can be manually pushed backward toward cabinet 12 which can cause arm members 52, 54 to rotate upward as shown schematically in FIG. 6B. Upon display screen 16 being moved into a position against the front portion of cabinet 12, one or more latches can be engaged to secure display screen 16 to the cabinet such that it is in the position for intended use as shown in FIG. 6A.

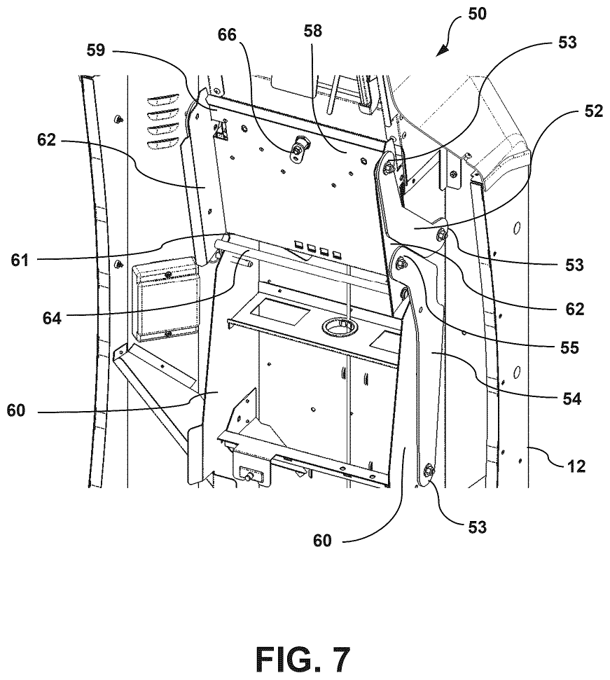

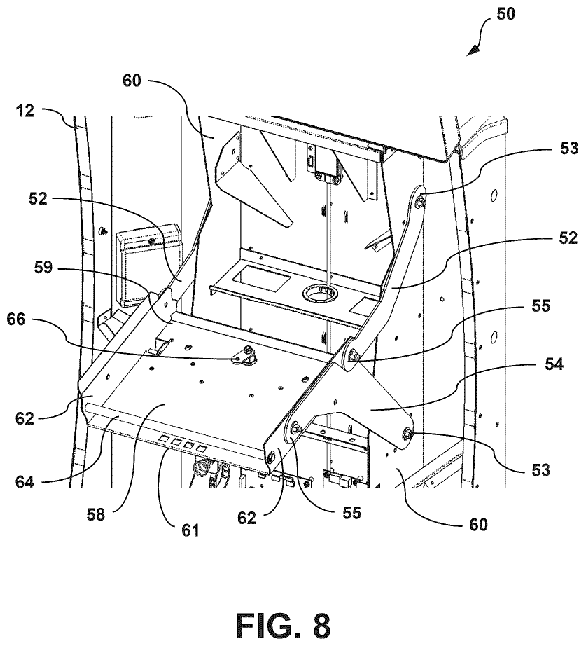

FIGS. 7 and 8 illustrate mounting assembly 50 in further detail including in both a raised position as shown in FIG. 8 (corresponding to the position of display screen 16 as shown in FIG. 6A) and in an extended position as shown in FIG. 8 (corresponding to the reclined position of display screen 16 as shown in FIGS. 6C and 6D). As shown schematically in FIGS. 7 and 8, mounting assembly 50 can have sets of rigid arm members 52, 54 and an articulating bracket 58. According to exemplary embodiments, arm members 52, 54 can be provided in pairs and can comprise plates or bars having a curved or elbowed shape along their length between opposing proximal and distal ends 53, 55. Proximal ends 53 of arm members 52, 54 can be rotationally secured to a portion of cabinet 12 such as interior support plates or an interior support frame 60 having vertically-oriented side surfaces. As shown in FIGS. 7 and 8, the proximal ends 53 of arm members 52 can be secured to cabinet 12 in a location that is above the location where the proximal ends 55 of arm members 54 are is secured to the cabinet. The opposing distal ends 55 of arm members 52, 54 can be rotationally secured to portions of articulating bracket 58. Such connections can be made by mechanical fasteners between the arm members 52, 54 and the support frame 60 or articulating bracket 58 as appropriate.

As shown in FIGS. 7 and 8, articulating bracket 58 can have a central support plate having opposing lateral edges forming raised side plates 62 that can be substantially perpendicular to the central support plate. The distal ends 55 of arm members 52, 54 can be secured to corresponding locations along the opposing side plates 62 including arm member 52 being secured proximate a first end 59 of bracket 58 and arm member 54 being secured closer to a second opposing end 61 of bracket 58. Articulating bracket 58 can further comprise a mounting bar or flange 64 to serve as the attachment point for rotationally securing the mounting frame 56 along the rear portion of display screen 16 (as best shown in FIGS. 6B-6D) to the mounting assembly 50. As shown in FIGS. 7 and 8, mounting assembly 50 can also comprise a cam lock 66 located along the central support plate of articulating bracket 58. Cam lock 66 can be used to in conjunction with fasteners to lock lower display 16 via mounting frame 56 (as shown in FIGS. 6B-6D) onto articulating bracket 58.

According to exemplary embodiments, upon disengaging mounting assembly 50 from the raised position shown in FIG. 7, the weight of the mounting assembly and display screen 16 can cause proximal ends 53 of arm members 52, 54 to rotate downward relative cabinet 12 and interior support frame 60. Such rotation can cooperatively enable articulating bracket to rotate relative arm members 52, 54. More particularly, the first end 59 of articulating bracket 58 secured proximate arm members 52 can rotate backward relative arm members 52, and the opposing end 61 of bracket 58 closer to the connection point with arm members 54 can rotate forward relative arm members 54. Thus, where mounting assembly 50 is in the raised/folded position as shown in FIG. 7, the downward rotation of arm members 52 and the outward rotation of bracket 58 can cause at least a portion of the raised side plates 62 of bracket 58 to rotate from a position adjacent an inside surface of arm members 52 (when mounting assembly 50 is in the raised position) to a position adjacent an inside surface of arm members 54 (when mounting assembly 50 is in the extended position).

As shown in FIGS. 7 and 8, the rotation of arm members 52, 54 and articulating bracket 58 as mounting assembly 50 moves away from the raised position can enable the bracket 58 to extend out in front of the cabinet 12 of gaming machine 10. Such rotation can cause articulating bracket 58 to move between a first orientation where bracket 58 extends upward and forward between the second end 61 and the first end 59 (when mounting assembly 50 is in the raised position) and a second orientation where bracket 58 extends upward and backward between the second end 61 and the first end 59 (when mounting assembly 50 is in the extended position). Such rotation can cooperatively enable the display screen 16 to move outward and downward relative the position for intended use. It will be further understood that display screen 16 (including the rear mounting frame 56) can be rotated along mounting bar 64 between an upright orientation consistent with FIG. 6C and a reclined orientation consistent with FIG. 6D.

From the foregoing, persons of ordinary skill in the art will appreciate that the mounting assembly 50 presented herein can provide an improved configuration for mounting and moving a display screen 16 between a position for use for a gaming machine 10 and an extended position where it can be readily accessed for installation, service or replacement. It will be further understood and appreciated that such mounting assembly 50 can enable a display screen 16 to be installed, serviced or replaced by a single service technician. Such benefits can decrease the time and expense of service work so that the gaming machine 10 can be configured for or returned to operation more rapidly. It will be further understood that such benefits can increase opportunities for play the gaming machine 10 which can be desirable to both players and gaming operators.

From the foregoing, it will be observed that numerous variations and modifications may be affected without departing from the spirit and scope of the invention. It is to be understood that no limitation with respect to the specific apparatus illustrated herein is intended or should be inferred. It is, of course, intended to cover by the appended claims all such modifications as fall within the scope of the claims.

Further, logic flows depicted in the figures do not require the particular order shown, or sequential order, to achieve desirable results. Other steps may be provided, or steps may be eliminated, from the described flows, and other components may be add to, or removed from the described embodiments.

What is claimed is:

1. A gaming machine comprising:
a cabinet;
a mounting assembly comprising a plurality of segments having spaced-apart side support members, a display screen being securable to the cabinet by said mounting assembly;
wherein the plurality of segments comprises a first segment and a second segment, the first and second segments having opposing first and second ends, the first end of the first segment being hingedly secured to the cabinet;
a slide mechanism provided between the first and second segments of the mounting assembly, the slide mechanism comprising a first profile and a second profile, the first profile being secured along at least a portion of a length of one of an interior or an exterior surface of the side support members of the first segment, the second profile being secured along at least a portion of a length of an interior or an exterior surface of the side support members of the second segment, the second profile being slidingly engaged with the first profile, and
wherein the second segment is configured for telescoping linear travel relative the first segment wherein the second segment travels between a first position wherein the second segment is nested within the first segment between the first and second ends thereof and a second position wherein second segments extends below the second end of the first segment, said telescoping linear travel being provided by the second profile sliding along a portion of the first profile.

2. The gaming machine of claim 1 wherein the plurality of segments of the mounting assembly comprise a third segment having spaced-apart side support members and further comprising:
a second slide mechanism provided between the second and third segments of the mounting assembly, the second slide mechanism comprising a first profile and a second profile, the first profile of the second slide mechanism being secured along at least a portion of the length of one of the interior or the exterior surface of the side support members of the second segment, the second profile of the second slide mechanism being secured along at least a portion of a length of an interior or an exterior surface of the side support members of the third segment, the second profile of the second slide assembly being slidingly engaged with the first profile of the second slide assembly, and
wherein the third segment is configured for telescoping linear travel relative the second segment wherein the third segment travels between a first position wherein the third segment is nested within the second segment between the first and second ends thereof and a second position wherein third segments extends below the second end of the second segment, said telescoping linear travel being provided by the second profile of the second slide mechanism sliding along a portion of the first profile of the second slide mechanism.

3. The gaming machine of claim 2 further comprising flanges along the spaced-apart side support members of the third segment, the flanges providing mounting surfaces for supporting the display screen, a mounting bracket secured to the display screen being securable to the mounting surfaces of the flanges.

4. The gaming machine of claim 3 further comprising the display screen, the display screen being movable in a substantially vertical direction between a raised position and a lowered position relative the cabinet by the telescoping linear travel of the second segment relative the first segment and by the third segment relative the second segment;
wherein the raised position is characterized by the second segment being in the first position nested within the first segment and the third segment being in the first position nested within the second segment, and
wherein the lowered position is characterized by the second segment being in the second position extended from the first segment and the third segment being in the second position extended from the second segment.

5. The gaming machine of claim 4 wherein the display screen is a first display screen and further comprising a second display screen, the second display screen being secured to the cabinet in a location below the first display screen when the first and second display screens are secured to the cabinet in positions for intended use with a game played on the gaming machine, the substantially vertical movement of the first display screen from the raised position toward the lowered position taking place in front of the second display screen.

6. The gaming machine of claim 1 further comprising a kick stand having opposing proximal and distal ends with a length therebetween, the proximal end being secured to a portion of the cabinet and the distal end being securable to a portion of the first segment to hold the mounting assembly away from the cabinet.

7. The gaming machine of claim 1 further comprising at least one latch mechanism, the at least one latch mechanism being engagable with the mounting assembly to secure the mounting assembly within the cabinet such that the display screen is in a position for intended use with a game played on the gaming machine, the at least one latch mechanism being disengagable to enable the second end of the first segment of the mounting assembly to rotate forward from the position for intended use.

8. The gaming machine of claim 1 wherein the cabinet has a top portion that slopes forward as it extends upward from a lower portion, the mounting assembly being secured proximate the top portion.

9. A mounting assembly for securing a display screen to a gaming machine, the mounting assembly comprising:
a plurality of segments having spaced-apart side support members, the display screen being securable to a cabinet of the gaming machine by said mounting assembly;
wherein the plurality of segments comprises a first segment and a second segment, the first and second segments having opposing first and second ends, the first end of the first segment being hingedly securable to the cabinet;
a slide mechanism provided between the first and second segments of the mounting assembly, the slide mechanism comprising a first profile and a second profile, the first profile being secured along at least a portion of a length of one of an interior or an exterior surface of the side support members of the first segment, the second profile being secured along at least a portion of a length of an interior or an exterior surface of the side support members of the second segment, the second profile being slidingly engaged with the first profile, and
wherein the second segment is configured for telescoping linear travel relative the first segment wherein the second segment travels between a first position wherein the second segment is nested within the first segment between the first and second ends thereof and a second position wherein second segments extends below the second end of the first segment, said telescoping linear travel being provided by the second profile sliding along a portion of the first profile.

10. The mounting assembly of claim 9 wherein the plurality of segments comprise a third segment having spaced-apart side support members and further comprising:
a second slide mechanism provided between the second and third segments of the mounting assembly, the second slide mechanism comprising a first profile and a second profile, the first profile of the second slide mechanism being secured along at least a portion of the length of one of the interior or the exterior surface of the side support members of the second segment, the second profile of the second slide mechanism being secured along at least a portion of a length of an interior or an exterior surface of the side support members of the third segment, the second profile of the second slide assembly being slidingly engaged with the first profile of the second slide assembly, and
wherein the third segment is configured for telescoping linear travel relative the second segment wherein the third segment travels between a first position wherein the third segment is nested within the second segment between the first and second ends thereof and a second position wherein third segments extends below the second end of the second segment, said telescoping linear travel being provided by the second profile of the second slide mechanism sliding along a portion of the first profile of the second slide mechanism.

11. The mounting assembly of claim 10 further comprising flanges along the spaced-apart side support members of the third segment, the flanges providing mounting surfaces for supporting the display screen, a mounting bracket secured to the display screen being securable to the mounting surfaces of the flanges.

12. The gaming machine of claim 10 further comprising a kick stand having opposing proximal and distal ends with a length therebetween, the proximal end being secured to a portion of the cabinet and the distal end being securable to a portion of the first segment to hold the mounting assembly away from the cabinet.

13. The gaming machine of claim 10 further comprising at least one latch mechanism, the at least one latch mechanism being engagable with the mounting assembly to secure the mounting assembly within the cabinet such that the display screen is in a position for intended use with a game played on the gaming machine, the at least one latch mechanism being disengagable to enable the second end of the first segment of the mounting assembly to rotate forward from the position for intended use.

14. A method of moving a display screen of a gaming machine between a position of intended use for a game played thereon and a service position, the method comprising:
providing a mounting assembly comprising a plurality of segments and at least one latching mechanism, the plurality of segments comprising at least first and second segments having opposing first and second ends, the mounting assembly supporting the display screen to a cabinet of the gaming machine;
unlatching the at least one latch mechanism to disengage the second end of the first segment of the mounting assembly from the cabinet;
rotating the second end of the first segment of the mounting assembly forward from to enable the mounting assembly and display screen to move into a substantially vertical orientation;
moving the second segment of the mounting assembly vertically downward relative the first segment, said downward movement lowering the display screen relative the cabinet.

15. The method of claim 14 wherein the plurality of segments of the mounting assembly comprises a third segment and further comprising:
moving the third segment of the mounting assembly vertically downward relative the second segment.

16. The method of claim 15 wherein the movement of the second segment of the mounting assembly relative the first segment and the movement of the third segment of the mounting assembly relative the second segment is provided by slidable engagement between profiles located along spaced apart side support members of the first, second and third segments.

17. A gaming machine comprising:
a cabinet;
a plurality of display screens comprising a first display screen and a second display screen, the second display screen being secured to the cabinet in a location below the first display screen when the first and second display screens are secured to the cabinet in positions for intended use with a game played on the gaming machine;
a plurality of mounting assemblies comprising a first mounting assembly and a second mounting assembly, the first display screen being securable to the cabinet by said first mounting assembly, the second display screen being securable to the cabinet by said second mounting assembly;
the first mounting assembly comprising:
a plurality of segments having spaced-apart side support members;
wherein the plurality of segments comprises a first segment and a second segment, the first and second segments having opposing first and second ends, the first end of the first segment being hingedly secured to the cabinet;
a slide mechanism provided between the first and second segments of the mounting assembly, the slide mechanism comprising a first profile and a second profile, the first profile being secured along at least a portion of a length of one of an interior or an exterior surface of the side support members of the first segment, the second profile being secured along at least a portion of a length of an interior or an exterior surface of the side support members of the second segment, the second profile being slidingly engaged with the first profile, and
wherein the second segment is configured for telescoping linear travel relative the first segment wherein the second segment travels between a first position wherein the second segment is nested within the first segment between the first and second ends thereof and a second position wherein second segments extends below the second end of the first segment, said telescoping linear travel being provided by the second profile sliding along a portion of the first profile;
the second mounting assembly comprising:
a plurality of rigid arm members comprising a first set of arm members and a second set of arm members, the plurality of arm members having a curved shape along their length between proximal and distal ends, the proximal ends of the plurality of arm members being rotatably secured to the cabinet of the gaming machine wherein the proximal ends of the first set of arm members are secured to a location on the cabinet that is above a location where the proximal ends of the second set of arm members are secured to the cabinet;
an articulating bracket having first and second ends and comprising lateral side edges and an attachment surface for securing the second display screen thereto, a mounting bracket secured to the second display screen being rotatably securable to the attachment surface;
wherein the lateral side edges of the articulating bracket are rotatably secured to the distal ends of the plurality of arm members wherein the distal ends of the first set of arm members are secured proximate the first end of the articulating bracket and the distal ends of the second set of arm members are secured closer to the second end of the articulating bracket;
wherein the plurality of arm members are rotatable between a raised position and an extended position, the distal ends of the first and second sets of arm members being lowered and extended outward by said rotation from the raised position towards the extended position;
wherein the first end of articulating bracket is located above the second set of arm members in the raised position and is rotated downward to a location adjacent the second set of arm members in the extended position, and wherein the second end of articulating bracket is in a first location adjacent a front side of the cabinet in the raised position and is rotated outward to a second location spaced further in front of the first location.

18. The gaming machine of claim 17 wherein the plurality of segments of the first mounting assembly comprise a third segment having spaced-apart side support members and further comprising:
a second slide mechanism provided between the second and third segments of the first mounting assembly, the second slide mechanism comprising a first profile and a second profile, the first profile of the second slide mechanism being secured along at least a portion of the length of one of the interior or exterior surfaces of the side support members of the second segment, the second profile of the second slide mechanism being secured along at least a portion of a length of an interior or an exterior surface of the side support members of the third segment, the second profile of the second slide assembly being slidingly engaged with the first profile of the second slide assembly, and
wherein the third segment is configured for telescoping linear travel relative the second segment wherein the third segment travels between a first position wherein the third segment is nested within the second segment between the first and second ends thereof and a second position wherein third segments extends below the second end of the second segment, said telescoping linear travel being provided by the second profile of the second slide mechanism sliding along a portion of the first profile of the second slide mechanism.

19. The gaming machine of claim 17 further comprising an attachment point where the mounting bracket for the second display screen is rotatably secured to the attachment surface of the articulating bracket such that a first portion of the second display screen is located to one side of the attachment point and a second portion of the second display screen is located to a second side of the attachment point opposite the first side, the second display screen being rotatable around the attachment point between an upright position and a reclined position, whereby in the upright position the first portion of the second display screen is above the second portion and in the reclined position the first portion is rotated backwards toward the cabinet and the second portion is rotated upward such that it is at least one of horizontally level with or above the first portion.
